(19) United States
(12) Patent Application Publication
(10) Pub. No.: US 2019/0337181 A1
(43) Pub. Date: Nov. 7, 2019

(54) STRIPPING CLAW

(71) Applicant: BOXPLAN GMBH & CO.KG, Radolfzell (DE)

(72) Inventor: Tobias JAKOB, Radolfzell (DE)

(73) Assignee: BOXPLAN GMBH & CO.KG, Radolfzell (DE)

(21) Appl. No.: 16/475,324

(22) PCT Filed: Jan. 16, 2018
(86) PCT No.: PCT/EP2018/050913

§ 371 Date: Jul. 1, 2019

(30) Foreign Application Priority Data
Jan. 18, 2017 (DE) 10 2017 100 900.0

(51) Int. Cl. B26D 7/18

(52) U.S. Cl. CPC B26D 7/1818; B26F 1/44

(57) ABSTRACT

The invention relates to a stripping claw for insertion into a stripping tool, which is intended to strip a break-off part from a planar workpiece and comprises at least two tips (6.1, 6.2) to be placed onto the break-off part. According to the invention, the region between the two tips (6.1, 6.2) has a concave design.

The invention relates to a stripping claw according to the preamble of claim 1.

### TECHNICAL FIELD

The invention relates to the field of stripping technology, in which a usage, but in particular also a waste (break-off part), is stripped from a planar material web. For this, punching devices are used, as described for example in DE 100 23 896 A1 or DE 20 2008 012 789 A1. A large area plate, usually made of wood, is used as a stripping tool, in which at certain positions, which are located in the region of the break-off part to be stripped, stripping claws are used. The insertion of the stripping claws is done manually by means of a hammer and an associated pin, which act on a contact surface of the stripping claw to be used in order to introduce said claw at a defined position in a defined depth of the plate-shaped stripping tool.

### BACKGROUND ART

Of crucial importance, however, is also the tip of the stripping claw, which acts on the usage or the waste. Here, mainly crown pins or also breakout claws are known and are described, for example, in DE 10 2012 103 858 A1. The crown pin is cylindrical, with the tip being round and covered with a plurality of spikes. This tip acts on the break-off part in a planar manner. An uncontrolled tilting of the break-off part during the removal from the punching sheet is counteracted thereby. Thereby, clearly more pressure acts on the break-off part. Negative influences, such as thick breakpoints, poor knife cuts or slightly inaccurate fitting of the punching sheet are optimally compensated.

On the other hand, a stripping claw is designed like a strip and has a linear tip with spikes arranged on both sides. These can only penetrate as far into the break-off part as they protrude the linear tip. Thereby, no resilience is present when penetrating the tip of stripping claws into the break-off part, which has shown to be negative in many applications.

### OBJECT OF THE INVENTION

The object of the present invention is to overcome the disadvantages of the background art. In particular, a stripping claw is to be provided, which is much more resilient and self-centering.

### Solution of the Object

The features according to claim 1 lead to the solution of the object.

In contrast to the straight or planar connection between the two tips known from the background art, which limits a penetration depth of the tips into the break-off part, the concave curvature of a ram reception permits a variation of the penetration depth, depending on what type of counter-pressure is established. A stripping claw according to the background art does not have a concave curvature in the form of the ram reception 7, but a planar surface, as the stripping claw according to the background art is held specially and driven into the stripping tool with a hammer. A concave curvature would be unfavorable in this respect. For example, if the stripping claw is arranged slightly obliquely with respect to the break-off part, that is, the end of the stripping claw does not proceed exactly parallel to the break-off part, a tip of the free end of the stripping claw first penetrates into the break-off part.

The ram reception is precisely important in the automated and mechanical insertion of the stripping claw into the stripping tool. The automated insertion of the stripping claw according to the invention can take place in that the stripping claw is inserted into a sleeve, not shown, of a machine for manufacturing a stripping tool.

The sleeve positions the stripping claw until a ram of the machine drives into the sleeve for manufacturing the stripping tool and the stripping claw is driven out of the sleeve and into the stripping tool.

For this, the ram drives into the ram reception and presses the stripping claw, which is driven into the stripping tool.

Due to the fact that the ram reception is concave, a self-centering of the stripping claw towards the ram is achieved. For this, the ram has a convex shape, which drives into the convex shape of the ram reception. Convex means here that the ram reception has a curvature to one end of the stripping claw. The end of the Stripping claw is the region that is first driven into the stripping tool during the automated insertion of the stripping claw.

Thereby, not only a self-centering is achieved, but also a favorable force absorption of the stripping claw through the ram. The ram reception of the stripping claw enables a favorable force distribution.

This is achieved in that the convex shape of the ram transfers the force to the concave shape of the ram reception and thereby enables an advantageous force distribution on the entire stripping claw, as a larger contact surface is made possible.

As a result of the curvature and the associated enlargement of the width of the penetrated tip, the counter-pressure of the break-off part increases, namely potentially, so that, by a yielding of the break-off part, the required parallelism can be restored and the second tip of the stripping claw penetrates into the break-off part. This resilience effects a self-centering of the stripping claw with respect to the break-off part, which contributes to a significant improvement of the process sequence.

At the same time, however, stripping of the break-off part from the break-out claw is facilitated, as the width of the tip is not increased continuously, but potentially by means of the curvature. When pulling the tip from the break-off part, a much faster loosening of the tip from the break-off part takes place in this manner.

Advantageous embodiments are described in the dependent claims.

Above all, it is considered preferably that the curvature proceeds in a uniform radius around a center point. However, the concept of the invention is also intended to comprise other concave curvatures, for example it is conceivable that the curvature is in several parts and that a tip increases higher towards one tip than to the other tip. But many geometrical configurations are possible here.

The invention is described in particular with respect to the stripping claw, but it is also possible with a crown pin, by the connection between the tips of the crown pin also being at least partially concavely curved.

### DESCRIPTION OF THE FIGURES

Further advantages, features and details of the invention will become apparent from the following description of preferred exemplary embodiments and by means of the drawings; these show in:

FIG. 1 a plan view of a stripping claw according to the invention;

FIG. 2 a perspective side view of the stripping claw according to FIG. 1;

FIG. 3 a perspective side view of another exemplary embodiment of a stripping claw according to the invention.

### EXEMPLARY EMBODIMENT

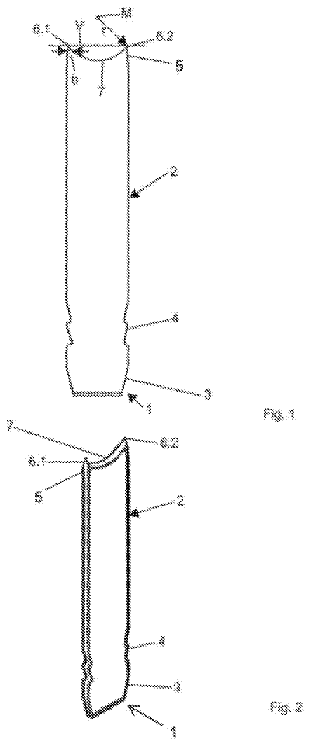

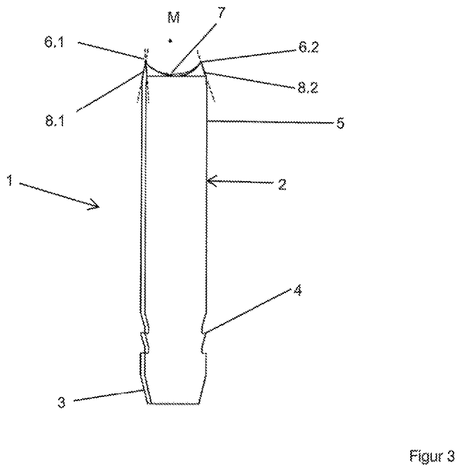

Referring to FIGS. 1 and 2, a stripping claw 1 according to the invention consists of a strip of material 2, which is formed in an approximately rectangular manner.

Its one end 3 is designed approximately conical, which serves for better insertion into a stripping tool not shown in detail or a part of the stripping tool not shown in detail. Abutments 4 also serve for this insertion.

Precisely the abutments 4 are to prevent, after the insertion of the stripping claw 1 into the stripping tool, that the stripping claw 1 slides out of the stripping tool conventionally manufactured of wood.

For the present invention, however, the free end 5 of stripping claw 1 opposite the end 3 is important. Said end has a concave ram reception 7 between two tips 6.1 and 6.2, that is, a curvature directed in the direction of the end 3 of the stripping claw 1.

This ram reception 7 has a radius r about an imaginary center point M. This center point M lies outside a line V indicated in a dot-dashed manner between the two tips 6.1 and 6.2, so that the ram reception 7 proceeds altogether open to the imaginary center point M.

The ram reception 7 is precisely important in the automated and mechanical insertion of the stripping claw 1 into the stripping tool. A stripping claw according to the background art does not have a concave curvature in the form of the ram reception 7, but a planar surface, as the stripping claw according to the background art is held specially and driven into the stripping tool with a hammer.

The operating principle of the present invention is as follows:

The stripping claw 1 is, for example, inserted into a sleeve of a machine, not shown in detail, for manufacturing a stripping tool. The sleeve holds the stripping claw 1 until a ram drives into the sleeve and the stripping claw 1 is driven out of the sleeve and into the stripping tool.

For this, the ram drives into the ram reception 7 and presses the stripping claw 1 and is driven into the stripping tool.

Due to the fact that the ram reception 7 is formed concave, a self-centering of the stripping claw towards the ram is achieved. For this, the ram has a convex shape, which drives into the convex shape of the ram reception. Thereby, not only a self-centering is achieved, but also a favorable force absorption of the stripping claw 1 through the ram. The ram reception 7 of the stripping claw 1 enables a favorable force distribution. This is achieved in that the convex shape of the ram transfers the force to the concave shape of the ram reception 7 and thereby enables an advantageous force distribution on the entire stripping claw, as a larger contact surface is enabled.

A plurality of said stripping claws 1 cooperate to break out a break-off part not shown in detail.

The stripping claws 1 are pressed onto the break-off part, so that the tips 6.1 and 6.2 penetrate into the break-off part. If, for example, a slightly oblique position is to be present between the break-off part and the stripping claw 1 or the plate-shaped break-off tool, one of the tips 6.1 or

6.2 penetrates into the break-off part in a leading manner.

However, as a width b of the tip increases as a result of the concave ram reception 7, the counter-pressure also increases, so that the break-off part can yield and the second tip 6.2 or 6.1 can penetrate into the break-off part. This is called self-centering.

On the other hand, stripping of the break-off part is facilitated by the free end 5 of the stripping claw 1 through the opening of the ram reception 7 selected due to the radius r, as the horizontal width b of the tip 6.1 or 6.2 increases potentially, the deeper the tip 6.1 or 6.2 penetrates into the break-off part.

In addition, FIG. 3 shows a further exemplary embodiment of a stripping claw 1 according to the invention. The features disclosed in FIGS. 1 and 2 also apply to the break-off claw 1. In particular, in cases where the same reference numerals have been used in FIGS. 1 and 2 and FIG. 3. In addition, in FIG. 3, a first chamfer 8.1 and a second chamfer 8.2 are shown. The first chamfer 8.1 shows a tapering of the tip 6.1 and the second chamfer 8.2. shows a tapering of the tip 6.2. These taperings are such that, on the one hand, a chamfer of the side edges to the point M takes place and, on the other hand, a flattening of the material strip 2 to the respective tips 6.1, 6.2.

LIST OF REFERENCE NUMERALS

| | |
|---|---|
| 1 | Stripping claw |
| 2 | Material strip |
| 3 | End |
| 4 | Abutment |
| 5 | free end |
| 6 | Tip |
| 7 | Ram reception |
| 8 | Chamfer |
| 9 | |
| 10 | |
| 11 | |
| 12 | |
| 13 | |
| 14 | |
| 15 | |
| 16 | |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| b | Width |
| M | Center point |
| r | Radius |
| V | Connection line |

1. A stripping claw for automated insertion into a stripping tool, which is intended to strip a break-off part from a planar workpiece and has at least two tips (6.1, 6.2) to be placed onto the break-off part,
characterized in that
a ram reception (7) is formed in a concave manner between the two tips (6.1, 6.2).

2. The stripping claw of claim 1, characterized in that the concave ram reception (7) has a radius (r) about a center point (M).

3. The stripping claw of claim 2, characterized in that the center point (M) is located outside a connection line (V) between the tips (6.1, 6.2).

4. The stripping claw of claim 1, characterized in that an end (3) is present, which comprises an abutment (4).

5. The stripping claw of claim 4, characterized in that a material strip (2) has the end (3) at one end and a free end (5) at the other end.

6. The stripping claw of claim 5, characterized in that the free end (5) comprises the two tips (6.1,6.2) and the ram reception (7).
